(19) United States
(12) Patent Application Publication
(10) Pub. No.: US 2006/0021234 A1
(43) Pub. Date: Feb. 2, 2006

(54) Inner cutter for a reciprocating electric shaver

(75) Inventors: Masami Yanosaka, Hikone-shi (JP); Junya Kanda, Hikone-shi (JP)

Correspondence Address: RADER FISHMAN & GRAUER PLLC, LION BUILDING, 1233 20TH STREET N.W., SUITE 501, WASHINGTON, DC, 20036, US

(73) Assignee: MATSUSHITA ELECTRIC WORKS, LTD.

(21) Appl. No.: 11/188,894

(22) Filed: Jul. 26, 2005

(30) Foreign Application Priority Data
Jul. 30, 2004 (JP) 2004-224479

(51) Int. Cl. B26B 19/04

(52) U.S. Cl. 30/346.51

(57) ABSTRACT

An inner cutter of the present invention is fabricated through the steps of: (a) preparing a metal sheet which is elongated to have a length and a width; (b) forming a plurality of slits in the metal sheet to form a plurality of crossbars separated by the slits along the length of the metal sheet; (c) processing the metal sheet to form sharp edges on opposite sides of each of the crossbars; (d) bending the metal sheet arcuately to form a blade which is curved arcuately along both the length and the width; (e) assembling the blade and a base into the inner cutter.

### TECHNICAL FIELD

The present invention relates to an inner cutter for a reciprocating electric shaver having an elongated outer cutter curved along its longitudinal direction.

### BACKGROUND ART

Japanese Non-examined Patent Publication No. 4-352988 discloses a reciprocating electric shaver having an elongated outer cutter curved convexly along its longitudinal direction. The electric shaver has an inner cutter comprising a blade composed of many metal pieces and a base for supporting the blade. In electric shavers of this kind, the blade of the inner cutter, as well as the outer cutter, needs to be bent convexly along its longitudinal direction.

In the above electric shaver, in order to bend the blade arcuately, first, the blade is held on a first base having elastic deformability, and then the first base is secured to a second base curved arcuately.

However, it is necessary for the blade of the above electric shaver to be ground by a concavely curved grinding wheel after the first base was fixed to the second base so as to form sharp edges on the blade. Therefore, the manufacturing process of the inner cutter was complicated.

### DISCLOSURE OF THE INVENTION

In view of the above problem, the object of the present invention is to provide an inner cutter which is easy to manufacture, and a method for creating the inner cutter.

An inner cutter in accordance with the present invention is used for a reciprocating electric shaver having an elongated outer cutter curved along its longitudinal direction. The inner cutter comprises a base carrying a blade, and is adapted to be driven in the longitudinal direction with the blade held in hair-shearing engagement with the outer cutter. The inner cutter is fabricated through the steps of:
(a) preparing a metal sheet which is elongated to have a length and a width;
(b) forming a plurality of slits in the metal sheet to form a plurality of crossbars separated by the slits along the length of the metal sheet;
(c) processing the metal sheet to form sharp edges on opposite sides of each of the crossbars;
(d) bending the metal sheet arcuately to form the blade which is curved arcuately along both the length and the width;
(e) assembling the blade and the base into the inner cutter.

That is to say, in the present invention, the sharp edges are formed on the opposite sides of each of the crossbars before the blade which is curved arcuately along both the length and the width is formed. So, it is not necessary to form sharp edges on the blade by a grinding wheel after the blade which is curved arcuately along both the length and the width is formed. Therefore, the inner cutter of the present invention is easy to manufacture.

Preferably, in the step (a), the metal sheet is a flat-shaped metal sheet, and in the above step (d), the flat-shaped metal sheet is bent arcuately along both its length and width to form the blade curved arcuately along both the length and the width. That is, in this case, the sharp edges are formed before the metal sheet is bent along both the length and the width, namely while the metal sheet is still flat. Therefore, it is easy to manufacture the blade having sharp edges.

Or, in the step (a), the metal sheet may be a half cylinder-shaped metal sheet, and in the step (d), the half cylinder-shaped metal sheet may be bent arcuately along its length to form the blade curved arcuately along both the length and the width. In this case, the sharp edges are formed before the metal sheet is bent along the length. Therefore, in this case, too, it is easy to manufacture the blade having sharp edges.

Preferably, each of the crossbars has the edges of generally 30 degrees on the opposite sides thereof. In this case, the sharpness, namely cutting ability, of the blade is good.

It is also preferable that the crossbars have both the edges of generally 30 degrees and the edges of more than 30 degrees. That is, some crossbars have the edges of about 30 degrees on the opposite sides thereof, and some crossbars have the edges of more than 30 degrees on the opposite sides thereof. By blending the edges of more than 30 degrees with the edges of about 30 degrees, it is possible to improve shaving sound while keeping the sharpness of the blade.

Preferably, the crossbars have nonuniform widths and/or lengths. In this case, too, the shaving sound can be improved.

Preferably, the slits have different lengths according to the shape of the metal sheet so that the metal sheet has uniform flexural rigidity in being bent arcuately. In this case, the metal sheet can be bent precisely, so that the precision of sliding surfaces of the blade to the outer cutter can be improved.

Preferably, the metal sheet has a concave portion for relieving wrinkles which generate when the metal sheet is bent arcuately. In this case, too, the metal sheet can be bent precisely, and furthermore, the appearance of the blade can be improved.

Preferably, the base has two or more protrusions for connection with the blade, the blade having two or more cuts engaged with the protrusions, the two or more cuts being arranged so that an opening of each of the cuts faces in the same direction when the metal sheet was bent arcuately. In this case, it is easy to connect the blade to the base because the openings of the cuts of the blade face in the same direction when the metal sheet was bent.

### BRIEF DESCRIPTION OF THE DRAWINGS

FIG. 1 is an exploded perspective view of an electric shaver having an inner cutter in accordance with an embodiment of the present invention.

FIG. 2A is a perspective view of a blade of the inner cutter.

FIG. 2B is a front view of the blade of the inner cutter.

FIG. 3 is a view showing a manufacturing process of the inner cutter.

FIG. 4 is a top view of the blade before a metal sheet is bent.

FIG. 5 is a section view of a crossbar of the blade.

FIG. 6 is a view showing another manufacturing process of the inner cutter.

FIG. 7 is a view showing another manufacturing process of the inner cutter.

FIG. 8 is a view showing another manufacturing process of the inner cutter.

FIG. 9 is a section view of a modified crossbar of the blade.

FIG. 10 is a section view of a modified crossbar of the blade.

FIG. 11A is a top view of a modified blade before the metal sheet is bent.

FIG. 11B is a front view of the blade of FIG. 11A after the metal sheet was bent.

### BEST MODE FOR CARRYING OUT THE INVENTION

Hereinafter, the present invention will be described in more detail with reference to the accompanying drawings.

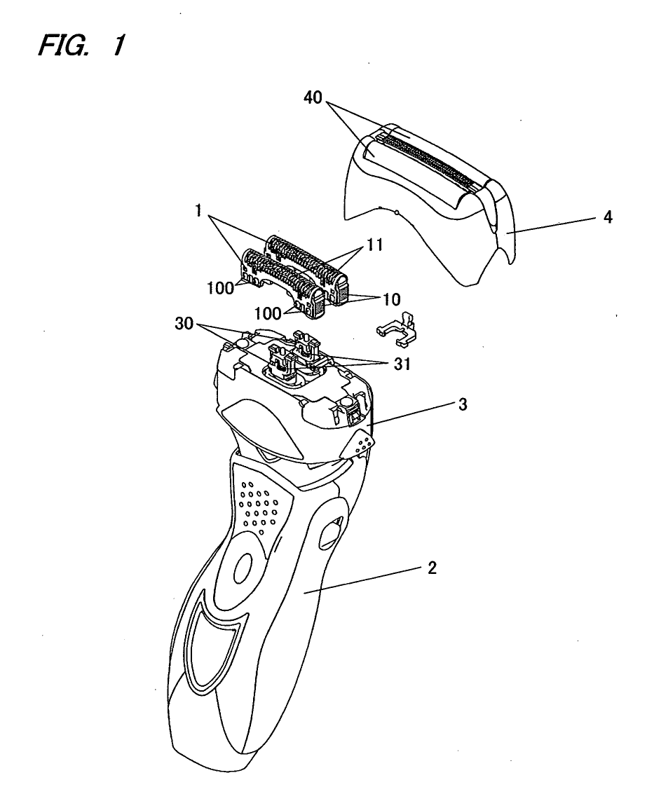

FIG. 1 shows a reciprocating electric shaver having an inner cutter 1 of the present invention. This electric shaver comprises a hand grip 2 adapted to be grasped by a user's hand, a movable head 3 supported on the top of the hand grip 2, two inner cutters 1 supported by driving elements 30 projecting from a top surface of the movable head 3, and an outer cutter block 4 detachably coupled to the movable head 3. The outer cutter block 4 includes two net-like outer cutters 40. Each of the outer cutters 40 is elongated to have a length and a width, and is curved arcuately along both the length and the width. The movable head 3 accommodates therein a liner motor (not shown), and the liner motor reciprocates the driving elements 30 along the length of the outer cutter 40. The inner cutters 1 are biased upwardly by springs 31 attached to the driving elements 30, and elastically contact with the outer cutters 40.

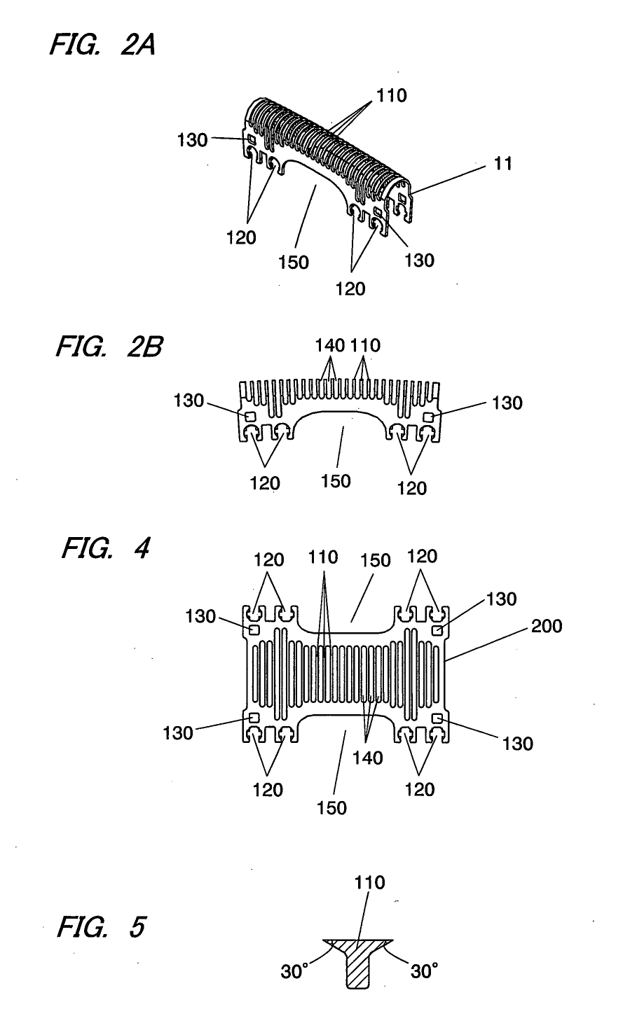

Hereinafter, the inner cutter 1 will be described in more detail. The inner cutter 1 comprises a base 10 carrying a blade 11, and is configured to be driven in its longitudinal direction by the liner motor with the blade held in hair-shearing engagement with the outer cutter 40. As shown in FIG. 2A and FIG. 2B, the blade 11, as well as the outer cutter 40, is elongated to have a length and a width, and is curved arcuately along both the length and the width. The blade 11 includes a plurality of crossbars 110 having sharp edges on its opposite sides for cutting the user's hair. Further, the blade 11 has a plurality of cuts 120 for connection with the base 10 and a plurality of holes 130 for heat sealing, on its four corners.

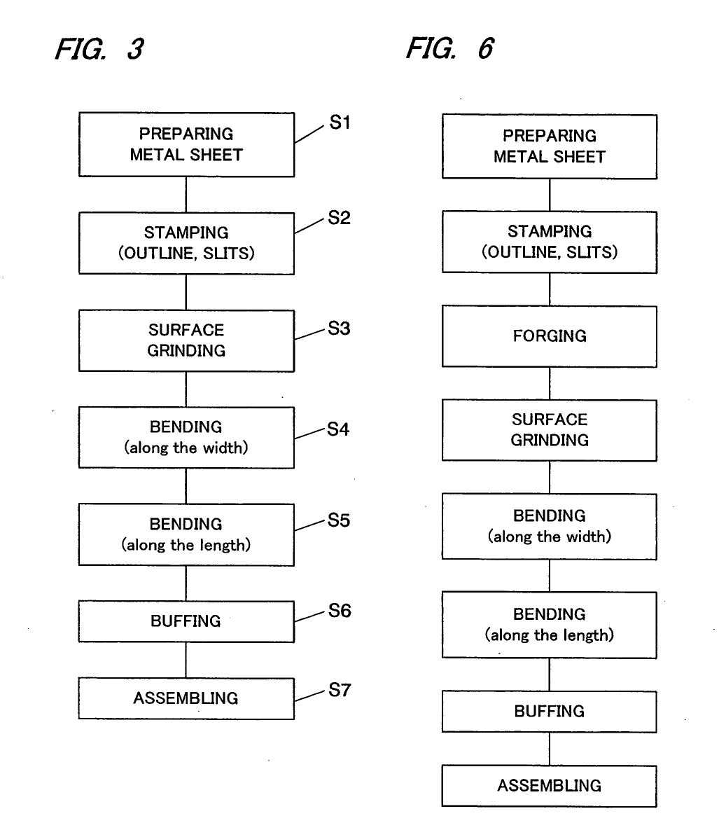

FIG. 3 shows an example of manufacturing process of the inner cutter 1. First, in step S1, a flat-shaped metal sheet 200 (see FIG. 4) which is elongated to have a length and a width is prepared. Then, in step S2, an outline of the blade 11 and a plurality of slits 140 are formed in the metal sheet 200 by stamping or cutting the metal sheet 200, as shown in FIG. 4. By forming the slits 140 in the metal sheet 200, a plurality of crossbars 110 each of which is separated by the slits 140 are formed in the metal sheet 200 along the length of the metal sheet 200. Then, in step S3, the rear surface of metal sheet 200 is processed by surface grinding to form sharp edges of about 30 degrees on the opposite sides of each of the crossbars 110, as shown in FIG. 5. By forming the sharp edges of about 30 degrees, the sharpness, namely cutting ability, of the blade 11 is improved. Then, in step S4, the metal sheet 200 is bent arcuately along the width, and then in step S5, the metal sheet 200 is bent arcuately along the length. Then, in step S6, the metal sheet 200 is buffed, whereby the blade 11 is completed. Then, in step S7, the blade 11 is secured to the base 10 with the cuts 120 engaged with protrusions 100 formed on the base 10 (see FIG. 1), whereby the inner cutter 1 is completed. In addition, the processing method of the edges of the crossbars 110 is not limited to the surface grinding, it may include, for example, forging, as shown in FIG. 6.

It should be noted that the sharp edges are formed on the opposite sides of each of the crossbars before the blade 11 which is curved arcuately along both the length and the width is formed. In other words, in this manufacturing process, the sharp edges are formed on the opposite sides of the crossbars 110 while the metal sheet 200 is still flat. Therefore, it is not necessary to form sharp edges on the blade by a grinding wheel after the metal sheet 200 was bent along both the length and the width. So, this inner cutter 1 is easy to manufacture. Furthermore, this inner cutter 1 has a low parts count.

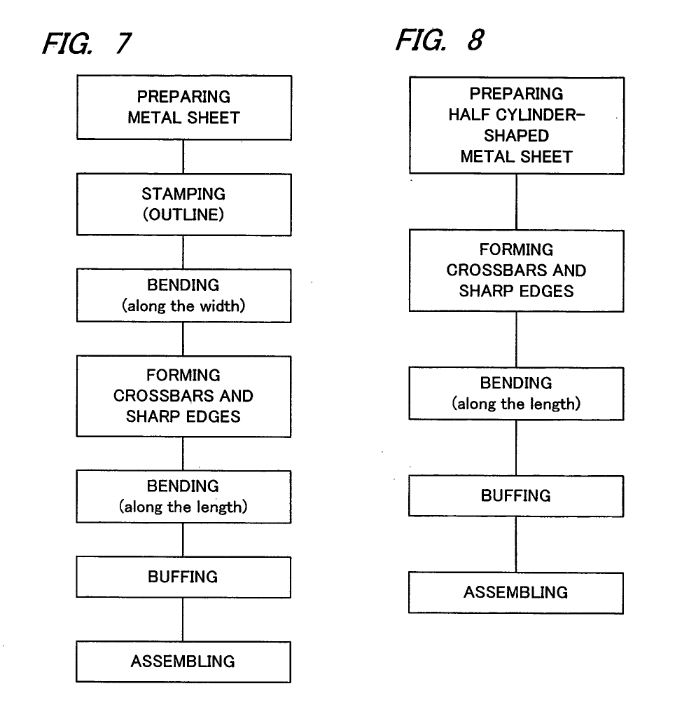

FIG. 7 shows a modified manufacturing process of the inner cutter 1. In this process, first, the flat-shaped metal sheet 200 is prepared, and the outline of the blade 11 is formed from the metal sheet 200 by stamping. Then, the metal sheet 200 is bent along the width. Then, a plurality of crossbars 110 are formed in the metal sheet 200, and the sharp edges are formed on the opposite sides of each of the crossbars 110. Then, the metal sheet is bent along the length to form the blade 11 which is curved arcuately along both the length and the width. And the blade 11 is buffed, and is secured to the base 10 to assemble the inner cutter 1.

As is clear from FIG. 7, in the present invention, the sharp edges may be formed after the metal sheet 200 was bent along the width and before the metal sheet 200 is bent along the length at the latest. In this case, too, the inner cutter 1 is easy to manufacture because the sharp edges are formed before the metal sheet 200 is bent along the length, namely before the blade which is curved along both the length and the width is formed. In addition, the sharp edges may be further processed by lapping and so on, after the metal sheet 200 was bent.

Instead of using the flat-shaped metal sheet 200, a half cylinder-shaped metal sheet may be used. In this case, as shown in FIG. 8, first, the half cylinder-shaped metal sheet is prepared, and then, the crossbars 110 and the sharp edges are formed in the half cylinder-shaped metal sheet, and then the half cylinder-shaped metal sheet is bent arcuately along its length, and the metal sheet is buffed, and it is secured to the base 10 to assemble the inner cutter 1. In this case, too, it is easy to manufacture the blade because the sharp edges are formed before the metal sheet 200 is bent along the length, namely while the metal sheet is still in a half cylinder-shaped configuration.

Now, turning back to FIG. 4, the metal sheet 200 is formed into a shape having concave portions 150 on opposite sides running in parallel with the length of the metal sheet 200, for relieving wrinkles which generate when the metal sheet 200 is bent arcuately along the length. By forming these concave portions 150, the metal sheet can be bent precisely, and the appearance of the blade can be improved.

Furthermore, in FIG. 4, the slits 140 (or the crossbars 110) have different lengths according to the shape of the metal sheet 200, so that the metal sheet 200 has uniform flexural rigidity in being bent arcuately along the length. That is, the slits 140 near the concave portions 150 and the holes 130 are formed to have a short length, and the slits 140 which are away from the concave portions 150 and the holes 130 are formed to have a long length, in order to equalize the flexural rigidity. When the metal sheet 200 has a uniform flexural rigidity, the metal sheet 200 can be bent precisely, so the precision of sliding surfaces of the blade 11 to the outer cutter 40 can be improved.

Furthermore, when the crossbars 110 (or the slits 140) have nonuniform lengths, shaving sound can be improved. In other words, the electric shaver can make a preferable sound when the user shaves his hair.

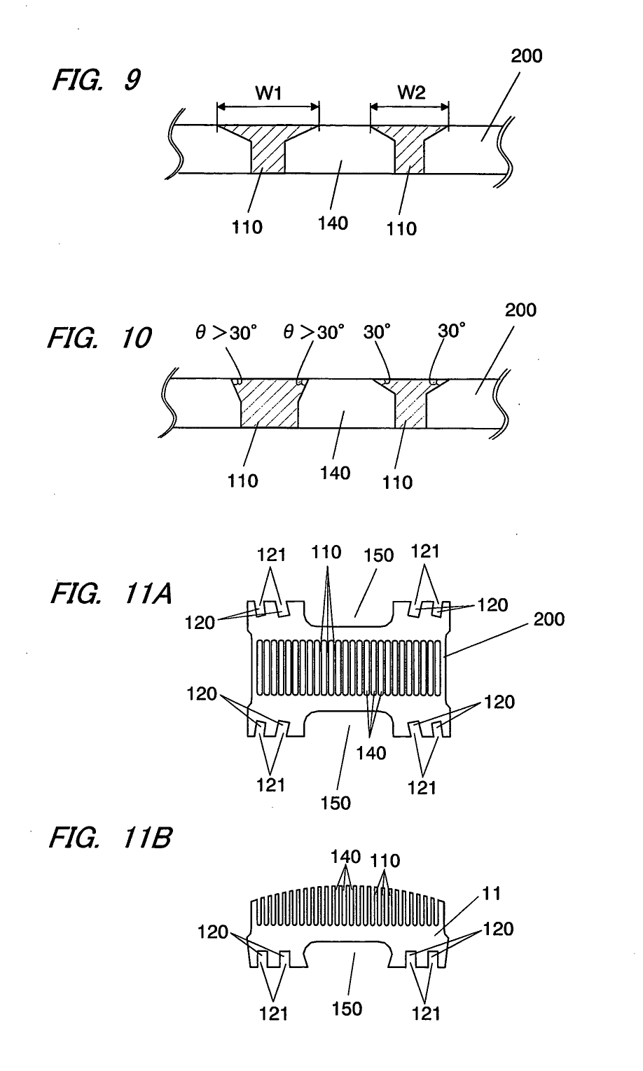

As shown in FIG. 9, the crossbars 110 may have nonuniform widths (W1≠W2). In this case, too, the shaving sound can be improved.

Furthermore, as shown in FIG. 10, the crossbars 110 may have both the edges of generally 30 degrees and the edges of more than 30 degrees (for example, 60 degrees). In other words, some crossbars 110 may have the edges with an angle e of about 30 degrees and some crossbars 110 may have the edges with an angle θ of more than 30 degrees. By blending the edges of more than 30 degrees with the edges of about 30 degrees, too, the shaving sound can be improved.

Furthermore, as shown in FIGS. 11A and 11B, the cuts 120 may be arranged so that an opening 121 of each of the cuts 120 faces in the same direction when the metal sheet 200 was bent arcuately. That is, while the metal sheet 200 is in the form of a flat shape, the cuts 120 may be inclined relative to the longitudinal direction of the metal sheet 200 as shown in FIG. 11A, and when the metal sheet 200 was bent arcuately, the openings 121 of all of the cuts 120 may face in the same direction, namely, the downward direction, as shown in FIG. 11B. In this case, it is easy to slide the cuts 120 onto the protrusions 100 of the base 10.

In addition, the shape of the slit 140 is not limited to a liner shape running in a direction perpendicular to the length of the inner cutter 1, and it may be a liner shape running in a slanting direction, or it may run in a zigzag manner.

As mentioned above, as many apparently widely different embodiments of this invention may be made without departing from the spirit and scope thereof, it is to be understood that the invention is not limited to the specific embodiments thereof except as defined in the appended claims.

1. An inner cutter for a reciprocating electric shaver having an elongated outer cutter curved along its longitudinal direction,
said inner cutter comprising a base carrying a blade and being adapted to be driven in the longitudinal direction with said blade held in hair-shearing engagement with said outer cutter,
said inner cutter is fabricated through the steps of:
(a) preparing a metal sheet which is elongated to have a length and a width;
(b) forming a plurality of slits in said metal sheet to form a plurality of crossbars separated by said slits along the length of the metal sheet;
(c) processing said metal sheet to form sharp edges on opposite sides of each of said crossbars;
(d) bending said metal sheet arcuately to form said blade which is curved arcuately along both the length and the width;
(e) assembling said blade and said base into said inner cutter.

2. The inner cutter as set forth in claim 1, wherein
said metal sheet is a flat-shaped metal sheet in the step (a),
said flat-shaped metal sheet being bent arcuately along both its length and width to form said blade in the step (d).

3. The inner cutter as set forth in claim 1, wherein
said metal sheet is a half cylinder-shaped metal sheet in the step (a),
said half cylinder-shaped metal sheet being bent arcuately along its length to form said blade in the step (d).

4. The inner cutter as set forth in claim 1, wherein
each of said crossbars has the edges of generally 30 degrees.

5. The inner cutter as set forth in claim 1, wherein
said crossbars have both the edges of generally 30 degrees and the edges of more than 30 degrees.

6. The inner cutter as set forth in claim 1, wherein
said crossbars have nonuniform widths.

7. The inner cutter as set forth in claim 1, wherein
said crossbars have nonuniform lengths.

8. The inner cutter as set forth in claim 1, wherein
said slits have different lengths according to the shape of said metal sheet so that the metal sheet has uniform flexural rigidity in being bent arcuately.

9. The inner cutter as set forth in claim 1, wherein
said metal sheet has a concave portion for relieving wrinkles which generate when the metal sheet is bent arcuately.

10. The inner cutter as set forth in claim 1, wherein
said base has two or more protrusions for connection with said blade,
said blade having two or more cuts engaged with said protrusions,
said two or more cuts being arranged so that an opening of each of said cuts faces in the same direction when said metal sheet was bent arcuately.

11. A method for creating an inner cutter for a reciprocating electric shaver having an elongated outer cutter curved along its longitudinal direction,
said inner cutter comprising a base carrying a blade and being adapted to be driven in the longitudinal direction with said blade held in hair-shearing engagement with said outer cutter,
said method comprising the steps of:
(a) preparing a metal sheet which is elongated to have a length and a width;
(b) forming a plurality of slits in said metal sheet to from a plurality of crossbars separated by said slits along the length of the metal sheet;
(c) processing said metal sheet to form sharp edges on opposite sides of each of said crossbars;
(d) bending said metal sheet arcuately to form said blade which is curved arcuately along both the length and the width;
(e) assembling said blade and said base into said inner cutter.
